(19) United States
(12) Patent Application Publication
(10) Pub. No.: US 2019/0369479 A1
(43) Pub. Date: Dec. 5, 2019

(54) PROJECTION SYSTEM

(71) Applicant: Young Optics Inc., Hsinchu (TW)

(72) Inventor: YI-HSUEH CHEN, Hsinchu (TW)

(21) Appl. No.: 16/540,354

(22) Filed: Aug. 14, 2019

Related U.S. Application Data
(63) Continuation of application No. 15/913,128, filed on Mar. 6, 2018.

(30) Foreign Application Priority Data
Mar. 8, 2017 (TW) TW106107645

(51) Int. Cl. G03B 33/12; G03B 21/14; G03B 21/00; G03B 21/20

(52) U.S. Cl. CPC G03B 33/12; G03B 21/2013; G03B 21/008; G03B 21/142

(57) ABSTRACT

A projection system includes a first light combining optical element, a first light valve, a first prism, a first lens group, a second light valve, a second prism and a second lens group. The first prism is disposed between the first light valve and the first light combining optical element. The first lens group is disposed between the first prism and the first light combining optical element. The second prism is disposed between the second light valve and the first light combining optical element. The second lens group is disposed between the second prism and the first light combining optical element.

### CROSS-REFERENCE TO RELATED APPLICATIONS

This is a continuation application of prior application Ser. No. 15/913,128 filed on Mar. 6, 2018. The entirety of the above-mentioned patent application is hereby incorporated by reference herein and made a part of this specification.

### TECHNICAL FIELD

The present invention relates to a projection system, and more particularly to a projection system including a plurality of light valves.

### BACKGROUND

With the development of technology and the great change in consumer demand, new types of projectors care continuously shown on the market. In response to the demand for increased brightness from consumers, more than one light valve structure is adopted to provide an image with a plurality of wavelengths at the same time, thereby improving the overall brightness of the projection system. The light valve can convert an illumination light into an image light, and the types of light valves include LCD, DMD or LCOS.

However, the existing common multi-valve projectors have the following shortcomings. First, a combination of a variety of optical phenomena increases the optical path between the light valve and the projection lens; therefore, the back focus length is increased, the lens volume is increased with the light cone, and consequently the cost and design complexity of the projection system are increased. Second, because each light valve uses a single common prism for light combining and therefore is not able to use the color band adjustment mechanism, the overfill must be enlarged to cover the action area of the valve in response to the different problems caused by different shapes of light spot of lights with different colors; however, the enlargement of overflow may cause a drop of usage efficiency of decline and affects the overall efficiency of the system. Third, a lens group capable of providing a variety of optical phenomena may have a larger thickness, which will result in increased material absorption and affect overall brightness.

### SUMMARY

One embodiment of the present invention provides a projection system. For example, in one embodiment, the projection system includes a first light combining optical element. The first light combining optical element is disposed on a common light path of the lights emitted by a first light valve and a second light valve, or the first light combining optical element is disposed between the first light valve and the second light valve. In addition, a first prism may be disposed between the first light combining optical element and the first light valve. The first prism may obtain an illumination light from a light source and provide it to the first light valve. The first light valve may convert the illumination light into an image light and transmit it to the first light combining optical element. The second prism may obtain an illumination light from the light source and provide it to the second light valve. The second light valve may convert the illumination light into an image light and transmit it to the first light combining optical element. As a result, the first light combining optical element may converge the image lights of the first light valve and the second light valve and project it outwardly.

Compared to the single prism light design in prior art, an embodiment of the present invention solves the problem of affected brightness efficiency caused by the long back focus, overfill and high thickness in the conventional design by distributing lights of different colors or polarities to a plurality of light valves and then using different prisms for light outputting.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic diagram of a projection system in accordance with the first embodiment of the present invention;

FIG. 2 is a schematic diagram of a projection system in accordance with the second embodiment of the present invention;

FIG. 3 is a schematic diagram of a projection system in accordance with the third embodiment of the present invention;

FIG. 4 is a schematic diagram of a projection system in accordance with the fourth embodiment of the present invention;

FIG. 5 is a schematic diagram of a projection system in accordance with the fifth embodiment of the present invention;

FIG. 6 is a schematic diagram of a projection system in accordance with the sixth embodiment of the present invention; and

FIG. 7 is a schematic diagram of a projection system in accordance with the seventh embodiment of the present invention.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

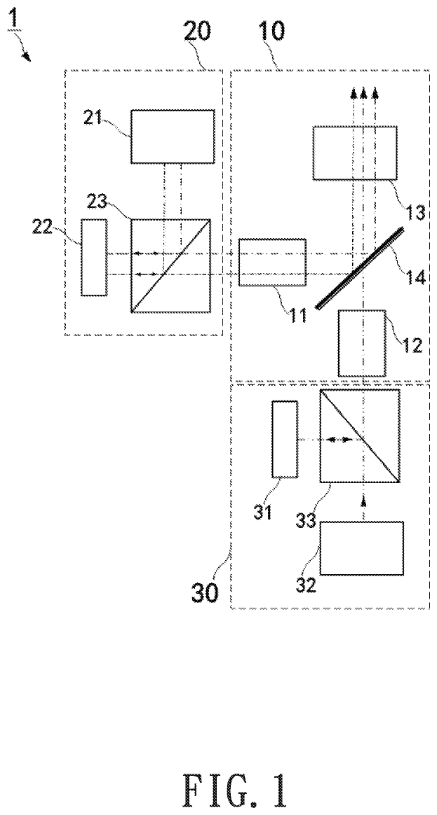

FIG. 1 is a schematic diagram of a projection system in accordance with the first embodiment of the present invention. As shown in FIG. 1, the projection system 1 of the present embodiment includes a projection lens 10, a first imaging module 20 and a second imaging module 30.

Each of the elements will be described below. In general, the projection lens 10 refers to a device that includes at least one lens. In general, the projection lens 10 may be disposed with an aperture stop, and one or more lenses may be disposed before and after the aperture stop. A lens in the present embodiment refers to, for example, a light transmissive optical element, and the radius of curvature of either the light entrance surface or the light exit surface of the light transmissive optical element is not infinite. More specifically, at least one of the light entrance and light exit surfaces of the light transmissive optical element is a curve surface. In other words, a flat glass is defined as not a lens in the embodiment. In the embodiment, the projection lens 10 includes a first lens group 11, a second lens group 12, a third lens group 13 and a first light combining optical element 14. In addition, an aperture stop (not shown) is also disposed.

The optical element in the present invention refers to an element formed of a material (such as glass or plastic) allowing a light to be, partially or totally, reflected or penetrated. The term “light combining” in the present invention means that combining more than one beam into a beam. The first light combining optical element 14 of the present invention may refer to a bandpass filter, a bandstop filter, a DM filter, a dichroic mirror, a DM prism, an X-type light combining filter group (X Plate), an X-type light combining prism (X prism) or a combination of at least two thereof. In addition, if necessary, the first light combining optical element 14 may be a semi-transmissive-and-semi-reflective sheet, a mirror, a lens, a flat glass or a polarizing beam splitter (BS), but the present invention is not limited thereto. In the case of a DM filter, a flat glass coated with a dichroic coating allows the light having a certain wavelength to be reflected or penetrated. In the present embodiment, the first light combining optical element 14 is a DM filter, which allows the green light to penetrate therethrough and the blue and red lights to be reflected thereby. One of the definitions of the aforementioned red light is that the spectrum of a light is located mainly in the wavelength range corresponding to red (e.g., between 625 nm and 740 nm); or the peak wavelength of the spectrum of a light is in the wavelength range corresponding to red.

Further, in general, the first lens group 11, the second lens group 12 and the third lens group 13 include at least one lens, preferably at least two lenses respectively; and usually the optical quality is improved with the number of lenses. In the present embodiment, the first lens group 11 is composed of two lenses, and the refractive power of the first lens group 11 is positive. The second lens group 12 is composed of two lenses, and the refractive power of the second lens group 12 is positive. The third lens group 13 is composed of one lens, and the refractive power of the third lens group 13 is negative. In addition, the third lens group 13 may further be selectively disposed with a flat plate or a mirror having a curvature. The first lens group 11, the second lens group 12 and the third lens group 13 are disposed on the three sides of the first light combining optical element 14, respectively. That is, the first light combining optical element 14 is disposed among the first lens group 11, the second lens group 12 and the third lens group 13 and is inclined at 45 degrees with respective to each of the first lens group 11, the second lens group 12 and the third lens group 13. The aperture stop (not shown) is disposed among the first lens group 11, the second lens group 12 and the third lens group 13. Specifically, the first lens group 11 and the second lens group 12 are disposed on the light entrance path of the first light combining optical element 14, and the third lens group 13 is disposed on the light exit path of the first light combining optical element 14.

The design of the first imaging module 20 will be described next. In general, an imaging module typically includes at least one light source, a light valve and a light guide element selectively disposed between the light source and the light valve. In the present embodiment, the first imaging module 20 includes a first light source 21, a first light valve 22 and a first light guide element 23.

In general, a light valve refers to an electronic device that converts an illumination light into an image light. A common light valve is, for example, a digital micro-mirror device (DMD), a liquid crystal display (LCD) panel or a liquid crystal on silicon (LCOS) panel. In the present embodiment, the first light valve 22 is a digital micro-mirror device.

In general, a light source can provide a light that can be non-visible, white, or having a specific wavelength range, such as blue, red or green lights. In addition, a light source may include any one or a combination of an incandescent lamp, a halogen bulb, a fluorescent lamp, a gas discharge lamp, a light emitting diode or a laser diode. In the present embodiment, the first light source 21 provides red and blue lights, and the red and blue lights are outputted by red and blue light emitting diodes, respectively. However, the light generation is not limited to the above means. For example, a red light can be generated by exciting a yellow phosphor with a blue ray and cooperating with a filter, or by passing a white light sequentially through a color wheel having a plurality of filter zones. Furthermore, the type of light source can also be adjusted in response to the design of the light valve. For example, if the light valve is liquid crystal, the light source is preferably capable of emitting a polarized light, and accordingly, the light source is selectively disposed with a phase retarder such as a ½ wave plate or a ¼ wave plate to adjust the polarization state of light.

The light guide element of the present invention refers to a prism or a polarizer filter. In general, a light guide element can guide a light in a totally internal reflection manner, or use a variety of polarized surfaces to control a particular light to be penetrated or reflected. For example, the light guide element can be a TIR prism, an RTIR prism, a polarizer prism or a polarizer filter. In the present embodiment, the first light guide element 23 and the second light guide element 33 are a TIR prism. When the first light guide element 23 and the second light guide element 33 are a prism, the first light guide element 23 and the second light guide element 33 may be referred to as a first prism and a second prism, respectively. In the present embodiment, it is to be noted that the TIR prism is a prism group composed of two jointed triangular columns, but the light guide element does not have to be composed of a plurality of prisms. For example, the light guide element may include only a prism if the light guide element is an RTIR prism. In addition, the first light guide element 23 may also refer to a prism group composed of a plurality of polygonal columns or cone (including triangular) columns cooperating with each other. In addition, when a plurality of prisms in the same prism group cooperates with each other, a gap may be selectively formed between them, and the gap is less than 1 mm, or less than 0.01 mm.

Furthermore, in general, the first lens group 34 includes at least one lens having a refractive power. As mentioned above, at least one of the light entrance and light exit surfaces of the lens is a curved surface. In the present embodiment, the refractive power of the first lens group 34 is positive.

In the present embodiment, the first light guide element 23 is disposed between the first light source 21 and the first light valve 22. In order to reduce the back focus length, the number of prism groups between the first light source 21 and the first light valve 22 is maintained to one in the present embodiment. More specifically, the light guide element between the first light source 21 and the first light valve 22 has only one light guide principle, for example, TIR or polarization splitting. Specifically, when the first light source 21 and the first light valve 22 have only one of the total reflection surface or the polarization splitting surface and without the both, the back focus length can be reduced greatly. In the present embodiment, before entering the light valve 22, the light output from the first light source 21 is guided only by the first light guide element 23 in the total internal reflection mechanism without being polarized. On the contrary, in other embodiments, if the polarization splitting is applied, the total reflection mechanism may be omitted to minimize the back focus length.

Next, the design of the second imaging module 30 will be described. In the present embodiment, the second imaging module 30 includes a second light source 31, a second light valve 32 and a second light guide element 33. In the present embodiment, the design of the second imaging module 30 is similar to the first imaging module 20, and only the differences between the two will be described below. For example, the second light source 31 outputs a green light.

The arrangement of the projection lens 10, the first imaging module 20 and the second imaging module 30 will be described below. As shown in FIG. 1, the first imaging module 20 is disposed to correspond to the first lens group 11 of the projection lens 10, and the second imaging module 30 is disposed to correspond to the projection lens 10. In addition, the angles of the image lights of the first imaging module 20 and the second imaging module 30 incident to the projection lens 10 may be substantially perpendicular to each other. In the present embodiment, the number of prism groups between the first light valve 22 and the first light guide element 23 is one; and the number of prism groups between the second light valve 32 and the second light guide element 33 is also the same.

Hereunder the traveling way of the light in the projection system of the present embodiment will be described. Specifically, the light source 21 of the first imaging module 20 emits a blue illumination light and a red illumination light. The illumination light is incident from one side of the TIR prism of the first light guide element 23, reflected by a reflection interface in a total internal reflection manner and outputted to the first light valve 22. The illumination light enters the first light valve 22 and is reflected to form an image light. The image light penetrates the aforementioned reflection interface and is outputted from the first light guide element 23. Then, the blue and green image lights penetrate the first lens group 11 in the projection lens 10 and enter the first light combining optical element 14. The first light combining optical element 14 reflects the blue and red image lights to the third lens group 13 for projection. Similar to the first imaging module 20, the green light of the second imaging module 30 penetrates the second lens group 12 and enters the first light combining optical element 14 after outputting from the second light guide element 33. The first light combining optical element 14 allows the red image light to penetrate and enter the third lens group 13 for projection.

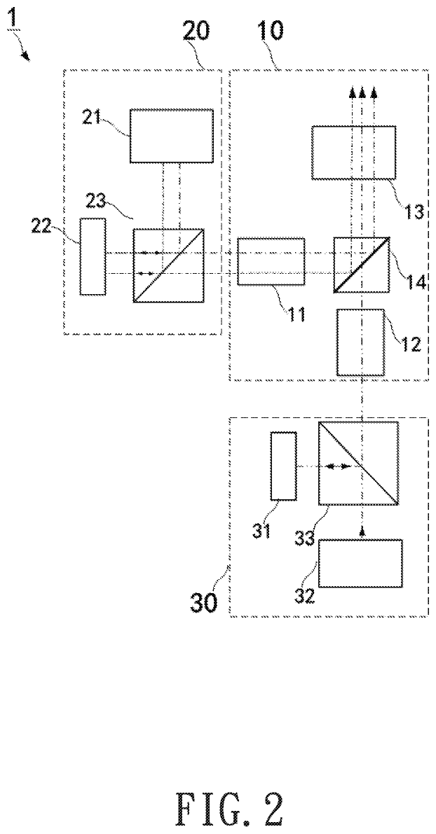

FIG. 2 is a schematic diagram of a projection system in accordance with the second embodiment of the present invention. As shown in FIG. 2, the difference from the first embodiment is that the first light combining optical element 14 in the projection lens 10 of the present embodiment is a DM prism.

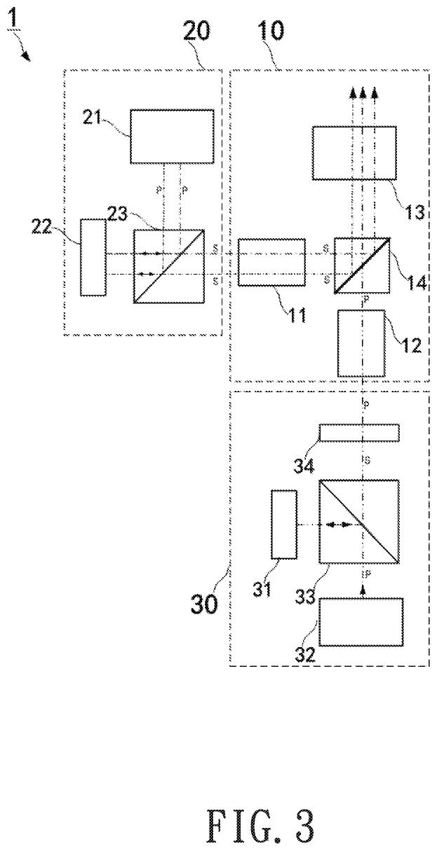

FIG. 3 is a schematic diagram of a projection system in accordance with the third embodiment of the present invention. As shown in FIG. 3, the difference from the first embodiment is that the present embodiment uses the polarization mechanism to perform the light combining. Specifically, in the present embodiment, the first imaging module 20 includes a first light source 21, a first light valve 22 and a first light guide element 23. The first light source 21 includes a light emitting diode light source. The first light source 21 provides two P-polar illumination lights with different colors, such as red and blue. The first light valve 22 is a LCOS panel. The first light guide element 23 is a polarizer prism, however, the first light guide element 23 may be replaced by a polarizer filter. The second imaging module 30 includes a second light source 31, a second light valve 32, a second light guide element 33 and a wave plate 34. The second light source 31 is a light emitting diode and provides a P-polar illumination light, wherein the illumination light is, for example, green. The second light valve 32 is a LCOS panel. The second light guide element 33 is a polarizer prism, however, the second light guide element 33 may be replaced by a polarizer filter. The wave plate 34 is a ½ wave plate.

In application, the first light source 21 provides two illumination lights with the same polarity but different colors; for example, the polarity may be S or P, and in the present embodiment the polarity is P. The second light source 31 provides an illumination light having a polarity same as that of the first light source 21 but a color different from that of the first light source 21; for example, the polarity of the illumination light disposed by the second light source 31 is P. The P-polar illumination light of the first light source 21 enters the first light guide element 23 and is reflected by the polarizing plate therein to enter the first light valve 22. The first light valve 22 converts the two P-polar beams into S-polar image lights and reflects the S-polar image lights toward the first light guide element 23, respectively. The image light enters the first light combining optical element 14 via the first lens group 11, and the first light combining optical element 14 reflects the S-polar light to the third lens group 13 for projection. After entering the second light guide element 33, the P-polar illumination light of the second light source 21 is reflected by the polarizing plate in the second light guide element 33 to enter the second light valve 32. The second light valve 32 converts the P-polar illumination light into the S-polar image light and reflects the S-polar image light toward the second light guide element 33. The image light enters the ½ wave plate 34 via the second lens group 12, and the ½ wave plate 34 adjusts the polarity of the light. In the present embodiment, the ½ wave plate 34 converts the S-polar image light into a P-polar image light. Thereafter, the P-polar light enters the first light combining optical element 14, and the first light combining optical element 14 allows the P-polar light to penetrate and enter the third lens group 13 for projection. In another example, the P and S of the respective polarities are interchangeable.

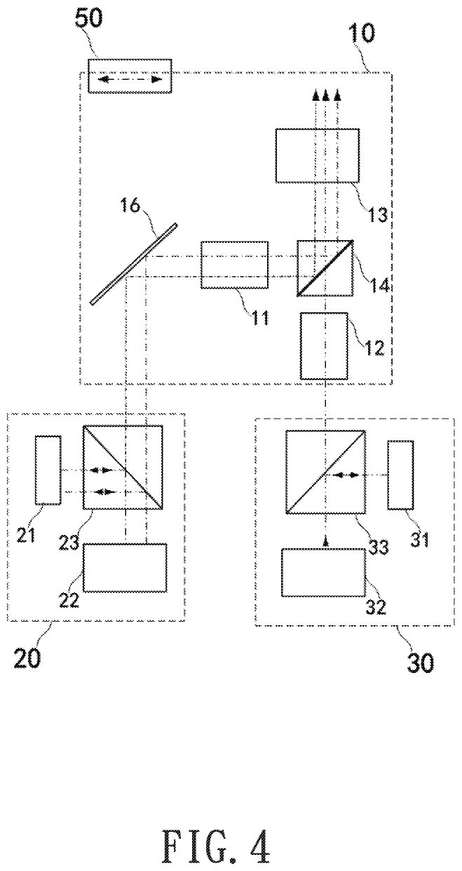

FIG. 4 is a schematic diagram of a projection system in accordance with the fourth embodiment of the present invention. As shown in FIG. 4, the difference from the first embodiment is that the positions of the first imaging module 20 and the second imaging module 30, and the projection lens 10 is disposed with a mirror 16 and a drive mechanism 50 connected to the projection lens. Specifically, in the present embodiment, the light exit direction of the first light valve 22 in the first imaging module 20 and the light exit direction of the second light valve 32 in the second imaging module 30 are substantially horizontal to each other. That is, in the present embodiment, the normal vector of the action surface of the first light valve 22 is identical to that of the second light valve 32, wherein the action surfaces of the first light valve 22 and the second light valve 32 are not limited to be substantially horizontal to the light exit direction. When the light valve is a DMD, the action surface refers to a region of the light valve disposed with a digital micro-mirror. After penetrating the first lens group 11, the image light of the first light valve 22 is reflected by the mirror disposed between the first lens group 11 and the first light guide element 14 to enter the first light combining optical element 14. Meanwhile, the entire projection lens 10 is interlinked with the drive mechanism 50. In the present embodiment, the drive mechanism 50 includes a scroll and a motor interlinked with one end of the scroll. The outside of the projection lens 10 is disposed with a bump embedded in the thread of the scroll. The motor can drive the scroll to rotate so that the bump of the projection lens 10 moves horizontally along the tangential vectors of the action surfaces of the first light valve 22 and the second light valve 32 thereby moving the projection lens 10. Thus, the design allows the projection system 1 to achieve the image displacement or lens-shift function.

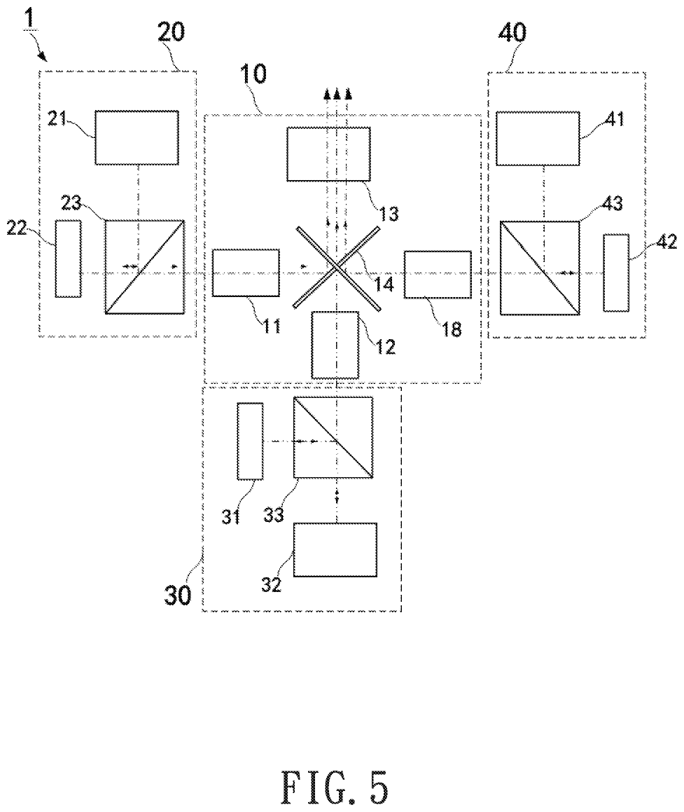

FIG. 5 is a schematic diagram of a projection system in accordance with the fifth embodiment of the present invention. As shown in FIG. 5, the difference from the first embodiment is that the present embodiment further includes a third imaging module 40. In addition, the design of the first imaging module 20 and the second imaging module 30 of the present embodiment is substantially the same as that in the previous embodiments, except that the light source 21 of the first imaging module 20 of the present embodiment outputs a light with a single color. That is, the blue, green and red lights are output from the first imaging module 20, the second imaging module 30 and the third imaging module 40, respectively. In another embodiment, the first imaging module 20, the second imaging module 30 and the third imaging module 40 output green, red and blue lights or red, blue and green lights, respectively. Further, the design of the first light combining optical element 14 among the first imaging module 20, the second imaging module 30 and the third imaging module 40 is different from that of the first embodiment. More specifically, in the present embodiment, the first light combining optical element 14 is an X-type light combining filter group (X Plate). The first imaging module 20, the second imaging module 30 and the third imaging module 40 are disposed on the three sides of the first light combining optical element 14, respectively. In the present embodiment, the light entrance directions of the first imaging module 20 and the third imaging module 40 with respective to the first light combining optical element 14 are substantially opposite to each other; and the light entrance direction of the second imaging module 30 is substantially vertical to the light entrance directions of the second imaging module 20 and the third imaging module 40. The traveling direction of the image light of the third imaging module 40 is similar to that of the first imaging module 10, and no redundant detail is to be given herein. In addition, the projection lens 10 is additionally disposed with a third lens group 18 corresponding to the third light valve 42.

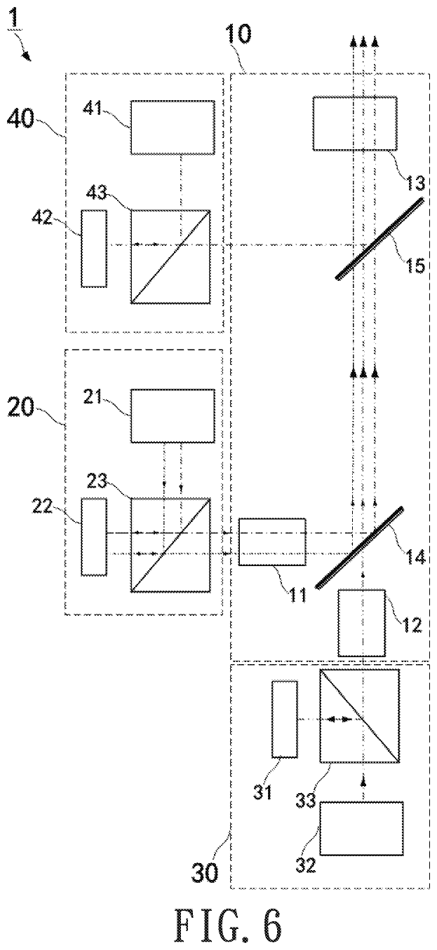

FIG. 6 is a schematic diagram of a projection system in accordance with the sixth embodiment of the present invention. As shown in FIG. 6, the difference from the first embodiment is that the present embodiment further includes a second light combining optical element 15, in addition to the first light combining optical element 14. In the present embodiment, the first light combining optical element 14 and the second light combining optical element 15 are a DM filter; and the first light combining optical element 14 and the second light combining optical element 15 are disposed horizontally. In addition, the present embodiment further includes a third imaging module 40. In addition, the design of the first imaging module 20 and the second imaging module 30 of the present embodiment is substantially the same as that in the previous embodiments, except that the light source 21 of the first imaging module 20 of the present embodiment outputs only a light with a single color. That is, the red, green and blue lights are outputted from the first imaging module 20, the second imaging module 30 and the third imaging module 40, respectively. Further, after passing through the first light combining optical element 14, the red and green image lights respectively outputted from the first light combining optical element 14 and the second light combining optical element 15 reach the second light combining optical element 15. That is, the second light combining optical element 15 is disposed on the traveling path of the aforementioned red and green image lights. In other words, one side surface of the second light combining optical element 15 faces the first light combining optical element 14, and the other substantially-perpendicular side surface faces the light exit direction of the third imaging module 40. Further, the blue image light of the third imaging module 40 is reflected by the second light combining optical element 15 and enters the third lens group 13 for projection. In addition, if necessary, the projection system 1 may be additionally disposed with a drive mechanism 50 so that the projection lens 10 can be moved in the tangential direction of the action surface of the first light valve 22 or the third light valve 42. The design of the drive mechanism 50 is described in the fourth embodiment, and no redundant detail is to be given herein.

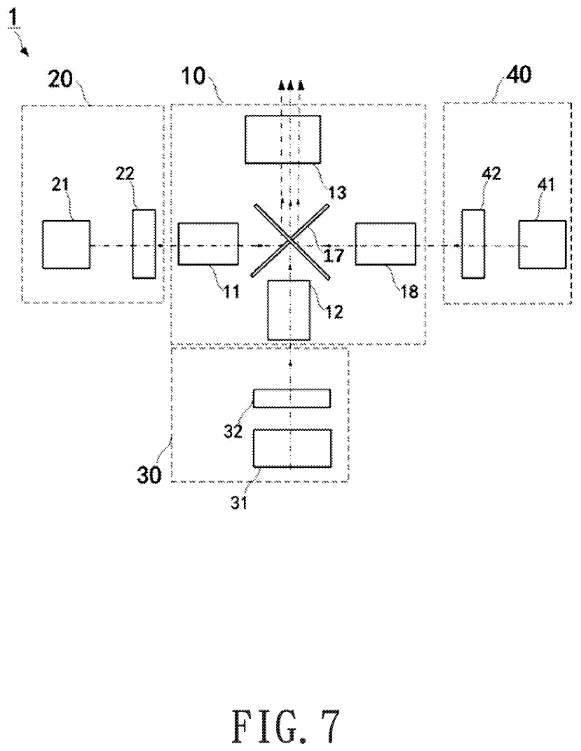

FIG. 7 is a schematic diagram of a projection system in accordance with the seventh embodiment of the present invention. As shown in FIG. 7, the overall architecture of the seventh embodiment is similar to the fourth embodiment, except that a light combiner 17 is disposed among the light valves in the first imaging module 20, the second imaging module 30 and the third imaging module 40 in the present embodiment. In addition, the light valves in the first imaging module 20, the second imaging module 30 and the third imaging module 40 are a transmissive light valve, and more specifically, a liquid crystal panel. The light combiner 17 can combine more than one beam into a beam. The light combiner 17 may be bandpass filter, bandstop filter, a DM filter, a dichroic mirror, a DM prism, an X-type light combining filter group (X Plate), an X-type light combining prism (X prism) or a combination of at least two thereof. In addition, if necessary, the light combiner 17 may be a semi-transmissive-and-semi-reflective sheet, a mirror, a lens, a flat glass or a polarizing beam splitter (BS).

In the present embodiment, the light entrance and light exit surfaces of the respective light valve are opposite to each other, and accordingly the light source of each imaging module is disposed at the light entrance surface of each light valve. The light exit surface of each light valve faces the light combiner 17. In the present embodiment, it is to be noted that since the light source is disposed at the rear of the light valve, there is no need to provide a light guide element between the light valve and the projection lens 10. In another aspect, the light combiner 17 is disposed among the first light valve 22, the second light valve 32, the third light valve 42 and the projection lens 10. The third lens group 13 is disposed in the opposite direction of the light combiner 17 with respect to the first light valve 22 or the second light valve 32. Further, the first lens group 11 and the second lens group 12 are disposed on the light entrance path of the light combiner 17, and the third lens group 13 is disposed on the light exit path of the light combiner 17.

Thus, compared to the single prism light design in prior art, an embodiment of the present invention solves the problem of affected brightness efficiency caused by the long back focus, overfill and high thickness in the conventional design by distributing lights of different colors or polarities to a plurality of light valves and then using different prisms for light outputting.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection system, comprising:
a light source, comprising:
a blue laser diode, capable of outputting a blue light beam;
a yellow phosphor, disposed downstream of the blue laser diode along a light path, the yellow phosphor being capable of outputting a yellow light beam by exciting the yellow phosphor with the blue light beam; and
a first filter, wherein a red light beam is generated by filtering the yellow light beam by the first filter;
a first prism set, disposed downstream of the first filter, the first prism set comprising two prisms separated by a gap less than 1 mm;
a first light valve, disposed downstream of the light source and the first prism set along the light path, the blue light beam and the red light beam entering the first light valve, the first light valve being capable of converting the blue light beam into a blue image beam, and converting the red light beam into a red image beam;
a second prism set, comprising two prisms separated by a gap less than 1 mm;
a second light valve, disposed downstream of the second prism set along another light path, and disposed on a light path of a green light beam, the second light valve being capable of converting the green light beam into a green image beam; and
a second filter, disposed downstream of the first light valve and the second light valve, the second filter allowing the green image beam to penetrate and capable of reflecting the blue image beam and the red image beam;
wherein the number of light valve in the projection system is two.

2. The projection system according to claim 1, wherein the second filter is a part of a DM prism.

3. The projection system according to claim 2, further comprising a projection lens, disposed downstream of the DM prism, wherein the projection lens is disposed with an aperture stop, and one or more lenses are disposed before and after the aperture stop.

4. The projection system according to claim 3, wherein the first light valve and the second light valve are a digital micro-mirror device (DMD).

5. The projection system according to claim 4, wherein the first light valve and the second light valve are perpendicular to each other.

6. The projection system according to claim 5, wherein the first prism set and the second prism set are both total internal reflection prism (TIR prism).

7. The projection system according to claim 8, further comprising a first lens group, disposed between the first light valve and the second filter.

8. The projection system according to claim 9, wherein the first lens group comprises at least two lenses and a refractive power of the first lens group is positive.

9. The projection system according to claim 10, further comprising a second lens group, disposed between the second light valve and the second filter.

10. The projection system according to claim 11, wherein the second lens group comprises at least two lenses and a refractive power of the second lens group is positive.
